(19) United States
(12) Patent Application Publication
(10) Pub. No.: US 2005/0240347 A1
(43) Pub. Date: Oct. 27, 2005

(54) Method and apparatus for adaptive filter based attitude updating

(76) Inventor: Yun-Chun Yang, Harbor City, CA (US)

Correspondence Address: Yun-Chun Yang;YH Technology, 26355 Pine Estates Drive, Harbor City, CA, 90710, US

(21) Appl. No.: 11/107,085

(22) Filed: Apr. 15, 2005

Related U.S. Application Data
(60) Provisional application No. 60/565,159, filed on Apr. 23, 2004.

(51) Int. Cl. G01C 21/00

(52) U.S. Cl. 701/220; 701/221

(57) ABSTRACT

A six state Kalman filter is adapted based on a current acceleration mode of an INS device. Gyro measurements are used to determine the acceleration mode and the Kalman filter estimates bias and small angle error of the measurements based on the acceleration mode. The bias error corrects the gyro measurement and the small angle error is used along with the corrected gyro measurement to update an attitude sensed by the gyro.

### CLAIM OF PRIORITY

This invention claims priority to the following co-pending U.S. provisional patent application, which is incorporated herein by reference, in its entirety:
Yang, Provisional Application Ser. No. 60/565,159, entitled “METHOD AND APPARATUS FOR ADAPTIVE FILTER BASED ATTITUDE UPDATING,” attorney docket no. 358637.00100, filed, Apr. 23, 2004.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of Invention

The present invention relates to inertial navigation systems. The present invention is more particularly related to inertial navigation and the determination of attitude based on inertial inputs. The invention is yet more particularly related to updating an attitude based on low cost MEMS based inertial devices.

2. Discussion of Background

Attitude determination is often required in spacecraft, aircraft, marine vessel, land vehicle, missiles, and other systems. These wide applications highlight the important role of determining attitude angles, which are the main navigation parameters that define the system's orientation relative to a certain frame. For example, if an acceleration is measured in the body frame, but must be corrected for gravity in the tangent frame, a rotation from the body frame to the local geodetic frame is often utilized. The rotation can be represented by an orthogonal rotation matrix, R_{a2b}, from the frame a to another frame b, which is a term used for the system control, guidance, and navigation.

The rotation matrix, from the body frame to the tangent frame, has a relationship with the attitude angles (called Euler angles: roll φ, pitch θ and yaw ψ) as:

$${R}_{b 2 t} = [ \begin{matrix}c ψ c θ & - s ψ c ϕ + c ψ s θ s ϕ & s ψ s ϕ + c ψ s θ c ϕ \\ s ψ c θ & c ψ c ϕ + s ψ s θ s ϕ & - c ψ s ϕ + s ψ s θ c ϕ \\ - s θ & c θ s ϕ & c θ c ϕ\end{matrix} ] \qquad ( 1 )$$

with s being the operation sin and c being the operation cos. Given R_{b2t}, the Euler angles can be calculated by the equations:

$$θ = - arctan ( \frac{{R}_{b 2 t} [ 3 , 1 ]}{\sqrt{1 - {{R}_{b 2 t} [ 3 , 1 ]}^{2}}} ) \qquad ( 2 )$$

φ=arc tan 2(R_{b2t},[3,2],R_{b2t}[3,3]) (3)
ψ=arc tan 2(R_{b2t}[2,1],R_{b2t,}[1,1]) (4)

Therefore, the attitude determination problem is equal to determining R_{b2t} for a moving platform from the body frame with respect to the tangent frame t.

Both Euler angles and the rotation matrix, R_{b2t}, are attitude representations. Different applications and situations have different attitude representations that are most convenient to implement. Several attitude representations have been investigated. They are discussed and summarized in Shuster, M. D., “A survey of Attitude Representation,” the journal of the Astronautical Science, Vol. 41, No. 4, October-December 1993, pp. 439-517.

Among these representations, the quaternion is best for attitude determination related to inertial navigation systems due to its excellent mathematical properties, dynamic equations, and calculation efficiency, while Euler angles have clear physical insights for analysis.

Strapdown Inertial Navigation Systems (INSS) can provide attitude and heading estimates after initialization and alignment by integrating the attitude rates that are related to attitude angles and the angle rate measurement of the gyroscopes. However, the pure INS implementation suffers from error growth due to the integration of the inertial gyro measurements that contain various errors. The MEMS based Inertial Measurement Unit (IMU) has difficulties being implemented as a pure INS due to its high error growth rate.

### SUMMARY OF THE INVENTION

The present inventor has realized an aided/augmented system with improved capability for INS error estimation. An IMU installed in a vehicle can estimate the pitch and roll angle of the body frame of the vehicle based upon the gravity vector, when the IMU is in the non-acceleration mode. However, when the vehicle is in a dynamic-acceleration mode, the gravity vector is difficult to use to estimate attitude due to its coupling with vehicle dynamics. A magnetic compass can read a heading of the vehicle based on the magnetic field of the earth in either case. However, in addition to a heading estimate from a magnetic compass, accurate angle information of pitch and roll are also needed. Thus, difficulties arise in determining attitude when using an IMU in the acceleration modes. The present invention obtains a near optimal attitude estimate for dynamic and stationary modes via data fusion. The present invention provides an extended Kalman filter with adaptive gain for an attitude determination system that is dependent upon the acceleration mode. In one embodiment, the present invention may be conveniently implemented in a miniature Attitude and Heading Reference System (AHRS) based upon a stochastic model.

In one embodiment, the present invention provides an attitude determination device, comprising, a mode determination mechanism configured to determine a current acceleration mode, and a Kalman filter adaptable to a set of acceleration modes and configured to determine an estimated error of an inertial device in the current acceleration mode.

In another embodiment, the present invention provides a device, comprising, an inertial device configured to make inertial readings, a dynamic model of the inertial device, a measurement model of the inertial measurement device, and a Kalman filter fitted to both the dynamic model and the measurement model and configured to produce an estimated error of the inertial device.

In another embodiment, the present invention comprises an adaptive filter, comprising a set of states for estimating errors, a time transition matrix for updating the states, and an adaptive update mechanism configured to adapt operation of the time transition matrix based on an operational mode of the adaptive filter.

The present invention includes a method, comprising the steps of, determining an acceleration mode, adapting a filter with parameters matching the determined acceleration mode, and applying the adapted filter to a correction value to determine an estimated error.

In several embodiments, estimated error of the present invention includes a bias error and small angle error for each axis of a gyroscope. The bias error estimate is used to correct a rotational rate reading and the corrected rotational rate reading and the small angle error estimates are utilized to update an initial attitude. In one embodiment, the attitude update is performed via a quaternion.

Portions of both the device and method may be conveniently implemented in programming implemented on a processing device, and the results may be displayed on an output device and/or utilized by other devices coupled, via any of hardwire, networked, or software connections to the processing device.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram according to an embodiment of the present invention;

FIG. 2 is a diagram of a board arrangement according to an embodiment of the present invention;

FIGS. 3A and 3B are an illustration of packaging utilized in an embodiment of the present invention;

FIG. 4 is a high level flow chart of a process according to an embodiment of the present invention;

FIG. 5 is a flow chart of an initialization and update process according to an embodiment of the present invention;

FIG. 6 is a flow chart of a quaternion update process according to an embodiment of the present invention;

FIG. 7 is a series of charts illustrating performance of an AHRS system according to an embodiment of the present invention in a stationary (non-acceleration) mode; and

FIG. 8 is a series of charts illustrating performance of an AHRS system according to an embodiment of the present invention in a dynamic mode.

### DESCRIPTION OF THE PREFERRED EMBODIMENTS

A strapdown Inertial Navigation System (INS) can provide attitude and heading estimates after initialization and alignment. Many factors affect the accuracy and the performance of the strapdown INS. Mainly, these factors are: sensor noise, bias, scale factor error, and alignment error. The Inertial Measurement Unit (IMU) based on the newly developed MEMS technology has wide applications due to its low-cost, small size, and low power consumption. However, the inertial MEMS sensors have large noise, bias and scale factor errors, mainly due to drift. Thus, the traditional strapdown algorithm using only low-cost MEMS sensors has difficulty satisfying the attitude and heading performance requirements.

An extended Kalman filter with adaptive gain (also referred to as an adaptive filter) may be used to build a miniature Attitude and Heading Reference System (AHRS) based on a stochastic model. The AHRS can be fitted within the size of 5 cm×5 cm×5 cm with analog to digital conversion and digital signal processing boards. The adaptive filter has, for example, six states with a time variable transition matrix. The six states are three tilt angles of attitude and three bias errors for the gyroscopes. The filter uses the measurements of three accelerometers and a magnetic compass to drive the state update. When the AHRS is in the non-acceleration mode, the accelerometer measurements of the gravity and the compass measurements of the heading have observability and yield good estimates of the states. When the AHRS system is in the high dynamic mode and the bias has converged to an accurate estimate, the attitude calculation will be maintained for a long interval of time. The adaptive filter tunes its gain automatically based on the system dynamics sensed by the accelerometers to yield optimal performance.

When a strapdown INS is not accelerating, the accelerometers' measurement vector in the body frame is related to the gravity vector in the tangent plane by the equation

$$[ \begin{matrix}{\overline{f}}_{u} \\ {\overline{f}}_{v} \\ {\overline{f}}_{w}\end{matrix} ] = {R}_{t 2 b} [ \begin{matrix}0 \\ 0 \\ g\end{matrix} ] = [ \begin{matrix}- sin θ \\ cos θsin ϕ \\ cos θcos ϕ\end{matrix} ] g \\ With {R}_{t 2 b} = {R}_{b 2 t}^{T} . \qquad ( 5 )$$

Based on eqn. (5), θ and φ can be estimated as

$$[ \begin{matrix}\hat{ϕ} \\ \hat{θ}\end{matrix} ] = [ \begin{matrix} arctan 2 ( {\overline{f}}_{v} , {\overline{f}}_{w} ) \\ arc tan 2 ( - {\overline{f}}_{u} , \sqrt{{\overline{f}}_{v}^{2} + {\overline{f}}_{w}^{2}} )\end{matrix} ] \qquad ( 6 )$$

where \overline{f}ᵤ, \overline{f}ᵥ, and \overline{f}_{w} are averages over any duration of time for which the velocity vector is constant.

The pitch and roll angles estimated by eqn. (6) are accurate to approximately the accelerometer bias divided by gravity, which is around 1 mrad/mg. For the low cost solid state accelerometers with 2 mg repeatability, the accuracy of the pitch and roll angles is about 0.11 degree.

A three-axis magnetic compass is mounted and aligned with the IMU. When we have estimates of the roll and pitch, the transition matrix from the body frame to the navigation frame is

$${R}_{b 2 t}^{rp} = [ \begin{matrix}c θ & s θ s ϕ & s θ c ϕ \\ 0 & c ϕ & - s ϕ \\ - s θ & c θ s ϕ & c θ c ϕ\end{matrix} ] \qquad ( 7 )$$

with s being the operation sin and c being the operation cos. Hence, the transition from the body frame of the magnetic compass to the local/tangent frame is

$$[ \begin{matrix}{m}_{xt} \\ {m}_{yt} \\ {m}_{zt}\end{matrix} ] = {R}_{b 2 t}^{rp} [ \begin{matrix}{m}_{xb} \\ {m}_{yb} \\ {m}_{zb}\end{matrix} ] \qquad ( 8 )$$

And the corresponding heading estimate is
\hat{ψ}=arc tan 2(m_{yt},mₓₜ) (9)

Given the attitude initialization and the gyroscope measurement, the attitude can be updated as a strapdown INS (attitude propagation based on gyroscope measurements). A quaternion may be used to perform the update. The quaternion is useful due to its good mathematical properties, dynamic equations, and calculation efficiency. The quaternion is detailed in Yang, Y., Tightly Integrated Attitude Determination Methods for Low-Cost Inertial Navigation: Two-Antenna GPS and GPS/Magnetometer, Ph.D. Dissertation, Dept. of Electrical Engineering, University of California, Riverside, CA June 2001. The application of quaternions to attitude updating is now discussed.

Denoting the gyro measurements as ω_{ib}^{b}=[p,q,r]^{T} with p, q, and r being three-axis angle rate in the body frame. The differential equation, related to the quaternion and the angle rate for quaternion propagation, is

$$\begin{matrix}\dot{q} = \frac{1}{2} [ \begin{matrix}0 & r & - q & p \\ - r & 0 & p & q \\ q & - p & 0 & r \\ - p & - q & - r & 0\end{matrix} ] q \\ = [ \begin{matrix}{q}_{4} & - {q}_{3} & {q}_{2} \\ {q}_{3} & {q}_{4} & - {q}_{1} \\ - {q}_{2} & {q}_{1} & {q}_{4} \\ - {q}_{1} & - {q}_{2} & - {q}_{3}\end{matrix} ] [ \begin{matrix}p \\ q \\ r\end{matrix} ]\end{matrix} \qquad ( 10 )$$

Hence, the quaternion can be calculated by integration of eqn. (10).

The normalization of q can be obtained from

$$[ p \times ] = [ \begin{matrix}0 & - {q}_{3} & {q}_{2} \\ {q}_{3} & 0 & - {q}_{1} \\ - {q}_{2} & {q}_{1} & 0\end{matrix} ] \qquad ( 13 )$$

The rotation matrix from the body frame to the tangent frame is calculated by
R_{b2t}=(q₄²−p^{T}p)I_{3×3}+2pp^{T}−2q₄[p×] (12)
with p=[q₁,q₂,q₃]^{T}, I_{3×3} being the identity matrix, and

$${q}_{n} = \frac{q}{{q}^{T} q} \qquad ( 11 )$$

And the q can be recalculated as:

$${q}_{4} = \pm \frac{1}{2} {( 1 + {R}_{11} + {R}_{22} + {R}_{33} )}^{0.5} \qquad ( 14 )$$

$$\begin{matrix}{q}_{1} = \frac{1}{4 {q}_{4}} ( {R}_{23} - {R}_{32} ) & ( 15 ) \\ {q}_{2} = \frac{1}{4 {q}_{4}} ( {R}_{31} - {R}_{13} ) & ( 16 ) \\ {q}_{3} = \frac{1}{4 {q}_{4}} ( {R}_{12} - {R}_{21} ) & ( 17 )\end{matrix}$$

The present invention provides an adaptable filter (adaptive filter) to estimate the attitude error and the sensor bias. The estimated error and bias are used in aiding/augmentation of the INS. Details of the adaptable filter are now discussed.

The error state of the attitude determination is formed as

$$δ x = [ \begin{matrix}δρ \\ {x}_{g}\end{matrix} ] \qquad ( 18 )$$

with δρ=[ε_{N},ε_{E},ε_{D}]^{T} being the small rotation angle error vector, and x_{g}=[gₓ,g_{y},g_{z}]^{T} being the gyro bias vector. The dynamic model of the state vector in eqn. (18) is where

$$\begin{matrix}[ \begin{matrix}δ \dot{ρ} \\ {\dot{x}}_{g}\end{matrix} ] = [ \begin{matrix}{F}_{ρρ} & {F}_{ρ {x}_{g}} \\ 0 & {F}_{{x}_{g} {x}_{g}}\end{matrix} ] [ \begin{matrix}δρ \\ {x}_{g}\end{matrix} ] + [ \begin{matrix} {ω}_{ρ} + {υ}_{g} \\ {ω}_{g}\end{matrix} ] \\ where & ( 19 ) \\ {F}_{ρρ} = [ \begin{matrix}0 & {ω}_{D} & - {ω}_{E} \\ - {ω}_{D} & 0 & {ω}_{N} \\ {ω}_{E} & - {ω}_{N} & 0\end{matrix} ] & ( 20 ) \\ {F}_{ρ {X}_{g}} = \frac{\partial ρ}{\partial {ω}_{ib}^{b}} \frac{\partial {ω}_{ib}^{b}}{\partial {x}_{g}} = {R}_{b 2 t} \frac{\partial {ω}_{ib}^{b}}{\partial {x}_{g}} = {R}_{b 2 t} & ( 21 ) \\ {F}_{{x}_{g} {x}_{g}} = 0 & ( 22 )\end{matrix}$$

In eqn. (20),

$${ω}_{N} = {ω}_{ie} cos λ + \frac{{υ}_{E}}{{R}_{Φ} + h} , {ω}_{E} = \frac{{υ}_{N}}{{R}_{λ} + h} , {ω}_{D} = {ω}_{ie} sin λ - \frac{tan ( λ ) {υ}_{E}}{{R}_{Φ} + h} .$$

In eqn. (22), x_{g} is modeled as a random walk process with Fₓ_{_{g}}ₓ_{_{g}} being 0. The spectral densities of the measurement noise process, ω_{ρ}+ν_{g}, can be determined by analysis of the measurement data; and the spectral densities of the drift noise process, ω_{g}, can be determined by analysis of the instrument bias over an extended period of time.

Turning now to the calculation of a discrete time state-transition matrix and a covariance matrix of the processing noise. The discrete time state transition can be described as
δxₖ₊₁=Φ_{((k+1)T,kT)}δxₖ+ω_{d(k)} (23)
with covariance propagation
Pₖ₊₁=Φ_{((k+1)T,kT)}PₖΦ_{((k+1)T,kT)}^{T}+Q_{d}_{ₖ} (24)

For best performance, these variables should be calculated online, as they depend on the real time attitude rotation matrix, latitude, height, and velocity. The online calculation of the discrete time dynamic residual state transition matrix, Φ, and the discrete time process noise covariance matrix, Q_{d}, is presented below.

The linearized error dynamics are described in eqn. (36). The terms F_{ρρ} are small (<10⁻⁶) and will be neglected in the calculation of Φ.

By setting the specified terms to zero and expanding the power series of

$${Φ}_{( {t}_{2} , {t}_{1} )} = [ \begin{matrix}I & {F}_{ρ g} T \\ 0 & I\end{matrix} ] \qquad ( 25 )$$

the following equation results

$${ⅇ}^{Ft} = I + Ft + \frac{1}{2} {( Ft )}^{2} … ,$$

Using the properties of state transition matrices,
Φ₍ₜ_{ₙ}_{,kT)}=Φ₍ₜ_{ₙ}_{,t}_{_{n−1}}₎Φ₍ₜ_{_{n−1}}_{,kT)} (26)
where Φ₍ₜ_{ₙ}_{,t}_{_{n−1}}₎ is defined in eqn. (25) with F_{ρg} being the values at the time interval [tₙ,tₙ₋₁) and Φ₍ₜ_{_{n−1}}_{,kT)} calculated from previous iterations by eqn. (25) and eqn. (26). The calculation of eqn. (26) is initialized with Φ_{((kT,kT)}=I and is continuing to iterate the interval of time propagation to yield Φ_{((k+1)T,kT)}. At t=(k+1)T, the state error covariance is propagated by eqn. (24).

For the present implementation, F_{pg}=R_{b2t}.

The discrete time process noise covariance for the [kT,(k+1)T)[ ]] interval is defined by

$${Q}_{{d}_{k}} = {\int }_{kT}^{( k + 1 ) T} {Φ}_{( ( k + 1 ) T , t )} {Q}_{( t )} {Φ}_{( ( k + 1 ) T , t )}^{T} ⅆ t \qquad ( 27 )$$

where Q₍ₜ₎ is the continuous time process noise covariance matrix. This integral can be approximated as

$${Q}_{{d}_{k}} = {{\sum }_{1}}^{N} {Φ}_{( {t}_{i + 1} , {t}_{i} )} {Q}_{( {t}_{i} )} {Φ}_{( {t}_{i + 1} , {t}_{i} )}^{T} {dT}_{i} \qquad ( 28 )$$

where t₁=kT,t_{N}=(k+1)T, dTᵢ=tᵢ₊₁−tᵢ, and

$${{\sum }_{1}}^{N} {dT}_{i} = T .$$

For the present implementation, dTᵢ=0.067s and

$$Q ( t ) = [ \begin{matrix}{Q}_{g} & 0 \\ 0 & {Q}_{gd}\end{matrix} ] \qquad ( 29 )$$

with
Q_{g}=R_{b2t}Σ_{g}²R_{b2t}^{T},
with
Q_{gd}=diag(σ_{qd}²,σ_{qd}²,σ_{qd}²)
In above,
σ_{g}=2.2×10⁻³ rad/s/\sqrt{Hz}
σ_{qd}=2.2×10⁻⁵ (rad/s)/\sqrt{Hz}
and since Σ_{g}=σ_{g}I in these equations,
R_{b2t}Σ_{g}²R_{b2t}^{T}=σ_{g}²R_{b2t}=IR_{b2t}^{T}=σ_{g}²I (30)

In one embodiment, two kinds of measurements are used for the error estimation. They are:
Accelerometer measurement model in non-acceleration mode: When |√{right arrow over (g_{b}_{ₓ}²+g_{b}_{_{y}}²+g_{b}_{ₓ}²)}−g|≦Thld,

$$\begin{matrix}δ f = {f}^{t} - {\hat{f}}^{t} & ( 31 ) \\ = {f}^{t} - {\hat{R}}_{b2t} {\tilde{f}}^{b} & \\ = {f}^{t} - ( I - [ δ ρ \times ] {R}_{b2t} {f}^{b} + {n}^{t} & \\ = [ \begin{matrix}0 & {ε}_{D} & - {ε}_{E} \\ - {ε}_{D} & 0 & {ε}_{N} \\ {ε}_{E} & - {ε}_{N} & 0\end{matrix} ] [ \begin{matrix}0 \\ 0 \\ g\end{matrix} ] + {n}^{t} & \\ = [ \begin{matrix}0 & - g & 0 \\ g & 0 & 0 \\ 0 & 0 & 0\end{matrix} ] [ \begin{matrix}{ε}_{N} \\ {ε}_{E} \\ {ε}_{D}\end{matrix} ] + {n}^{t} & ( 32 )\end{matrix}$$

where
\hat{R}_{b2t}=(I−[δρ×])R_{b2t}+h.o.t.'s (33)
with

$$[ δ ρ \times ] = [ \begin{matrix}0 & {ε}_{D} & - {ε}_{E} \\ - {ε}_{D} & 0 & {ε}_{N} \\ {ε}_{E} & - {ε}_{N} & 0\end{matrix} ] \qquad ( 34 )$$

being the skew-symmetric matrix formed by the small rotation angle error vector δρ=[ε_{N},ε_{E},ε_{D}]^{T} to align the calculated tangent frame to the true tangent frame, and h.o.t.'s being the high order term's error.

From eqn. (32) the error states of ε_{N} and ε_{E} can be estimated, while the error state of ε_{D} is not observable.

Magnetic compass measurement model: The residual between the magnetic compass reading and the calculated heading is
δψ=\tilde{ψ}−\hat{ψ}=ε_{D}+n_{ψ} (35)

Adaptive gain for extended Kalman filter is now discussed. A Kalman filter is used to aid/augment the attitude angle estimation. The calculated attitude angles based on the gyroscope measurement integration, following initialization, serve as a reference trajectory around which the residual state error equations are linearized. The residual error state estimation is implemented, for example, based on the linearized error dynamics presented in equation (eqn.) (19). The six residual states are defined in eqn. (18) with three tilting angle errors and three gyroscope bias errors. The continuous time dynamic matrix is

$$F = [ \begin{matrix}{F}_{ρ ρ} & {F}_{ρ {x}_{g}} \\ 0 & {F}_{{x}_{g} {x}_{g}}\end{matrix} ] \qquad ( 36 )$$

with the variables defined above.

However, eqn. (19) is the continuous time linearized dynamic equation. A discrete time implementation of the Kalman filtering utilizes a discrete time state propagation matrix, Φ, and a discrete time process noise covariance matrix, Q_{d}, background, and appropriate expressions for these two quantities are discussed in Yang, Y., Tightly Integrated Attitude Determination Methods for Low-Cost Inertial Navigation: Two-Antenna GPS and GPS/Magnetometer, Ph.D. Dissertation, Dept. of Electrical Engineering, University of California, Riverside, CA June 2001.

Combining the measurement models of the tangent frame acceleration residual defined in eqn. (32) and magnetic compass heading measurement residual define in eqn. (35) and rearranging them yield

$$\begin{matrix}[ \begin{matrix}δ {f}_{{ε}_{N}} \\ δ {f}_{{ε}_{E}} \\ δ ψ\end{matrix} ] = H δ x + [ \begin{matrix}{n}_{{ε}_{N}} \\ {n}_{{ε}_{E}} \\ {n}_{ψ}\end{matrix} ] & ( 37 ) \\ where & \\ H = [ \begin{matrix}0 & - g & 0 & 0 & 0 & 0 \\ g & 0 & 0 & 0 & 0 & 0 \\ 0 & 0 & 1 & 0 & 0 & 0\end{matrix} ] & ( 38 )\end{matrix}$$

with the state variables and other terms defined above.

The residual states and their covariance time updates, for every measurement interval, are
δxₖ₊₁⁻=0 (39)
Pₖ₊₁⁻=Φ_{((k+1)T,kT)}Pₖ⁺Φ_{((k+1)T,kT)}^{T}+Q_{d}_{ₖ} (40)

When valid measurements are available, the filter gains are calculated as
Kₖ₊₁=Pₖ₊₁⁻Hₖ₊₁^{T}(Hₖ₊₁Pₖ₊₁⁻Hₖ₊₁^{T}+Rₖ₊₁)⁻¹ (41)
with R being the measurements covariance matrix corresponding to eqn. (37), the residual state covariance matrix and residual state measurement updates are estimated as

$$δ {x}_{k + 1}^{+} = {K [ \begin{matrix}δ {f}_{{ε}_{N}} \\ δ {f}_{{ε}_{E}} \\ δ ψ\end{matrix} ]}_{k + 1} \qquad ( 43 )$$

due to the predicted residual states δxₖ₊₁⁻=0. The is fed back to correct attitude angle and gyro bias, xₖ₊₁=xₖ₊₁+δxₖ₊₁⁺. Since the attitude state has now been updated to account for δxₖ₊₁⁺, δxₖ₊₁⁻ is set to zero and the process continues.

Regardless of whether valid measurements are available or not, the Kalman filter time update is processed with eqn. (39) and eqn. (40) for the next step. The only difference between the measurements being available and not being available is whether Pₖ₊₁⁺ is updated or not. When the measurements are not available, Pₖ₊₁⁺ is updated solely by setting Pₖ₊₁⁺=Pₖ₊₁⁻.

R can be determined by spectral density analysis of the measurement noise of the accelerometer and magnetic compass, while the Q_{d} can be determined by spectral density analysis of the process noise of the gyroscope and its associated drift. When the system is in the stationary mode, the determined R and Q_{d} can be used to drive the Kalman filter to yield the optimal gain for best state estimation. However, in the dynamic mode, the measurements of the accelerometer consist of the gravity vector plus the dynamic accelerations. The adaptation of the filter is to tune the R of the accelerometer to yield the optimal performance. Define the scalar dynamic acceleration as
+=|{square root over (g_{b}_{ₓ}²+g_{b}_{_{y}}²+g_{b}_{ₓ}²)}−g| (44)
the measurements covariance matrix, based on eqn. (37), as

$$R = [ \begin{matrix}{r}_{{ε}_{N}} & 0 & 0 \\ 0 & {r}_{{ε}_{E}} & 0 \\ 0 & 0 & {r}_{ψ}\end{matrix} ] \qquad ( 45 )$$

and the mapped standard deviation based on eqn. (32) as

$$[ \begin{matrix}{σ}_{{ε}_{N}} \\ {σ}_{{ε}_{E}} \\ {σ}_{{ε}_{D}}\end{matrix} ] = {R}_{b2t} [ \begin{matrix}{σ}_{{a}_{x}} \\ {σ}_{{a}_{y}} \\ {σ}_{{a}_{z}}\end{matrix} ] \qquad ( 46 )$$

with the σₐ_{ᵢ} being the standard deviation of the i-axis accelerometer. The adaptable gain has the following scenarios: In non-acceleration mode: When α≦{square root over (σₐ_{ₓ}²+σₐ_{_{y}}²+σₐ_{_{z}})},
r_{ε}_{_{N}}=σ_{ε}_{_{N}}² (47)
r_{ε}_{_{E}}=σ_{ε}_{_{E}}² (48)
r_{ψ}=σ_{mc}² (49)
with σ_{mc} being the standard deviation of the magnetic compass heading and others defined above. In this mode, the filter is accurately and properly modeled as a stochastic process with an optimal estimate resulting.

In low-acceleration mode: In this mode, {square root over (σₐ_{_{z}}²+σₐ_{_{y}}²+σₐ_{_{z}}²)}<α≦Thld_{acc}. [Thld_{acc} being an acceleration threshold establishing an upper acceleration value for the low acceleration mode. In one embodiment the Thld_{acc} is, for example, 0.1 g.] The uncertainty of the acceleration for the attitude estimation should be proportional to α and

$$\frac{1}{P}$$

with P being the covariance matrix of the attitude. Hence, the measurements covariance matrix can be written as:

$${r}_{{ε}_{N}} = s \frac{{α}^{2}}{{P}_{{ε}_{N}}} {σ}_{{ε}_{N}}^{2} \qquad ( 50 )$$

$${r}_{{ε}_{E}} = s \frac{{α}^{2}}{{P}_{{ε}_{E}} {σ}_{{ε}_{E}}^{2}} \qquad ( 51 )$$

r_{ψ}=σ_{mc}² (52)
with s being the scalar parameter that needs to be tuned. In this mode, the gain of the Kalman filter will be adjusted automatically based on the parameters, α, P_{ε}_{_{N}}, σ_{ε}_{_{N}}, P_{ε}_{_{E}}, and σ_{ε}_{_{E}}.

In high-acceleration mode: In this mode, α>Thld_{acc}, the system is in high dynamics, and the attitude estimation based on the accelerometer measures of the gravity is far away from the truth. Therefore, the measurements covariance matrix can be written as:
r_{ε}_{_{N}}=Thld_{big} (53)
r_{ε}_{_{E}}=Thld_{big} (54)
r_{ψ}=σ_{mc}² (55)
with Thld_{big} being a big number close to infinity. The corresponding gains of ε_{N} and ε_{E} will be close to 0.

In both low-acceleration and high-acceleration modes, the two thresholds of Thld_{acc} and Thld_{big} are determined by the experimental results and any design requirements of the applications.

Hardware of an embodiment of the present invention is now described. The inertial instruments consist of three-axis 2g, 5g or 10g solid-state accelerometers (e.g., 100 Hz bandwidth), three-axis

$$100 \frac{deg}{s} , 200 \frac{deg}{s} or 300 \frac{deg}{s}$$

solid-state gyroscopes (e.g., 25 Hz bandwidth), three-axis magnetic resistor sensors, 16-bit AD conversion and UART board, and a floating point TI DSP board. The system performs anti-alias filtering, analog-to-digital conversion, start-up bias correction, axis-misalignment correction, and yields a set of six inertial measurements and magnetic measurements. Those measurements are used to estimate both attitude and heading as described above with an output rate of about 120 Hz.

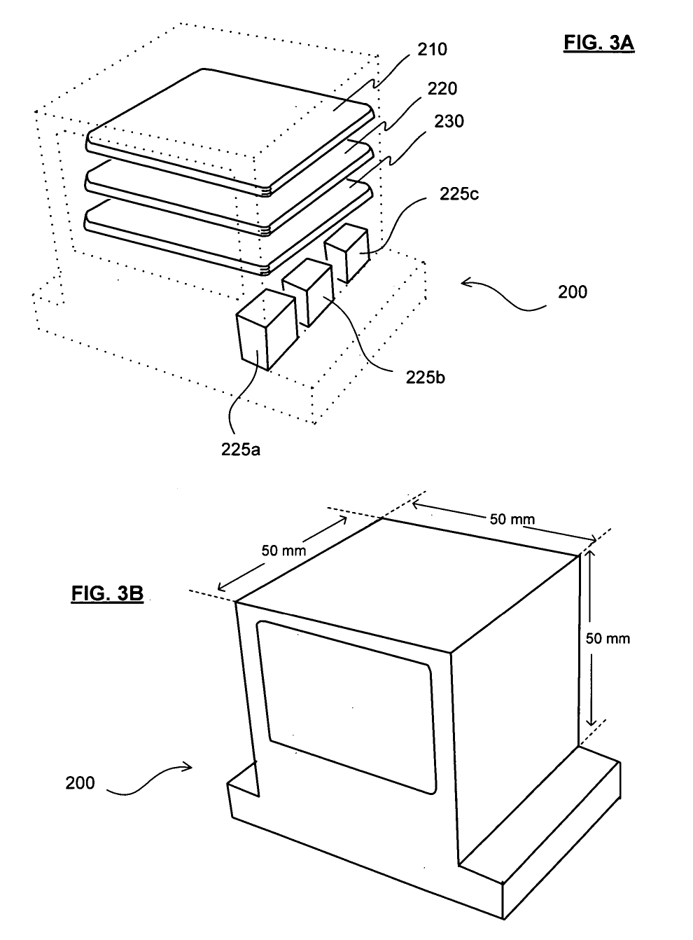

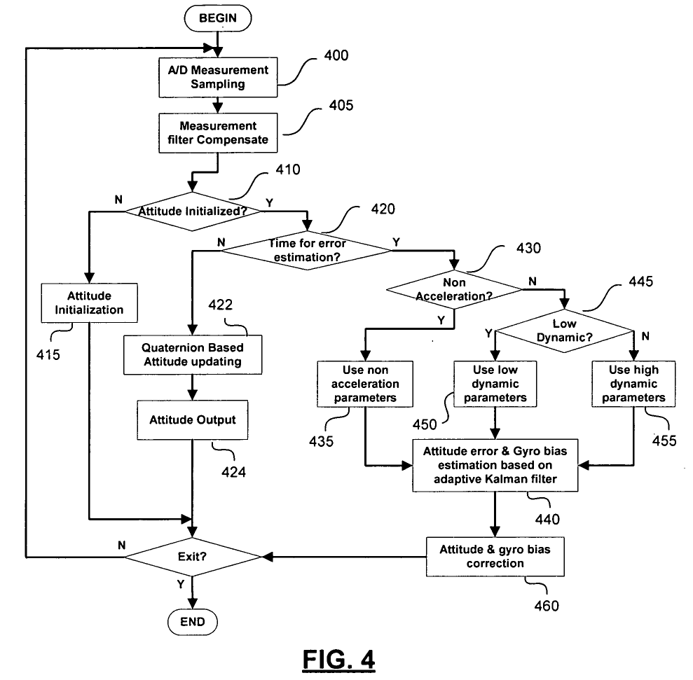

As shown in FIGS. 3A and 3B, the entire AHRS may, for example, be built within a volume of 50×50×50 mm³ with three PCB boards 110, 115, 120, and 125 containing the above described hardware and processing capabilities. Other selections of parts or arrangements on other circuit boards, the volume may be reduced further.

In one embodiment, the AHRS operated in the fixed tangent plane system at 120 Hz. The origin is fixed at a location of the system center. The navigation states include: roll, pitch, and yaw angles in radians; and, platform frame gyro drift rates

$$\frac{rads}{( s )} .$$

The attitude errors are estimated in the navigation frame as the north, east, and down tilt errors. The whole system is implemented as an embedded system with real-time data acquisition and processing.

System aiding/augmentation is implemented by an Extended Kalman Filter (EKF) in feedback configuration. The EKF time propagation is given by the Φ and Q_{d} parameters as defined in Yang, Y., Tightly Integrated Attitude Determination Methods for Low-Cost Inertial Navigation: Two-Antenna GPS and GPS/Magnetometer, Ph.D. Dissertation, Dept. of Electrical Engineering, University of California, Riverside, CA June 2001. The measurement update is implemented at a 5.0 Hz rate with scalar measurement processing using the H matrix defined above. The covariance R for each measurement update is dependent on the system acceleration mode of operation as discussed above to adaptively adjust the gain.

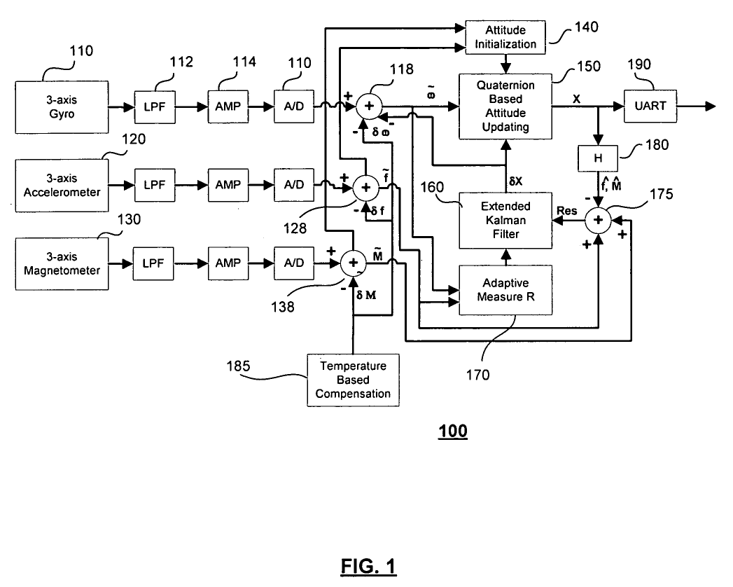

FIG. 1 is a block diagram of an attitude updating device 100 according to an embodiment of the present invention. The attitude updating device includes a 3-axis gyro [110], which is, for example, an Inertial Measurement Unit (IMU) constructed using low-cost MEMS technology. The gyro [110] provides a signal comprising a measurement of a 3-axis rotation rate of the attitude updating device 100. In one embodiment, the measured 3-axis rotation rate is equivalent to a rotation rate for a vehicle or other system in which the attitude updating device 100 is installed. Low Pass Filter (LPF) 112 and amplifier 114 condition the signal from the gyro 110 (e.g., remove noise from the measurement signal and amplify). An A/D converter 116 converts the signal to, for example, a series of digital words for further processing by a signal processing portion of the attitude updating device 100.

A 3-axis accelerometer 120 provides a signal comprising a measurement of a linear acceleration acting upon the attitude updating device 100. The linear acceleration signal is conditioned, for example, by a series LPF and amplifier (AMP), and then converted to a digital signal (e.g., digital word(s)) by an A/D converter.

A 3-axis Magnetometer 130, provides a signal comprising a magnetic reading of heading of the attitude updating device 100. The heading signal is conditioned, for example, by a series LPF and amplifier (AMP), and then converted to a digital signal (e.g., digital word(s)) by an A/D converter.

A temperature based compensation module 185 provides a temperature based correction. The temperature based correction module includes, for example, a temperature sensor whose output is used to index a lookup table of correction factors. In one embodiment, the lookup table provides an error correction factor for each of a discrete series of temperature ranges for each of the measurement devices (e.g., gyros, accelerometers, and heading measurement devices). Other correction factors may also be included and applied. The error correction factor for a current operating temperature for a specific one of the measurement devices is applied to the conditioned signal from the specific device. For example, in the embodiment of FIG. 1, temperature based compensation module 185 provides a correction factor at a current operating temperature for the 3-axis gyro 110 which is applied the A/D converted signal from the gyro at summer 118. Similarly, correction factors for each of the 3-axis accelerometer 120 and 3-axis magnetometer 130 are applied at summer 128 and summer 138 respectively.

In another embodiment, the temperature correction factors are determined by evaluating a polynomial or a process whose end result is an appropriate temperature based compensation.

The A/D converted and temperature compensated accelerometer and magnetometer signals are input to an attitude initialization device to determine an initial attitude. In one embodiment, the initial attitude is performed one time (e.g., on power up), after which the attitude is continually updated by an attitude update module (e.g., quaternion attitude updating 150). In other embodiments, attitude may be periodically re-initialized at certain appropriate times during use (e.g., an unexpected or unrecoverable error may, for example, invoke a re-set or re-initialization of attitude). However, the attitude updates performed by a process consistent with the present invention are accurate enough that re-initialization of the system is not needed under normal conditions.

An extended Kalman filter 160 constructed according to an embodiment of the present invention produces a δx, which, in one embodiment, as described above, comprises 6 error values. The 6 error values are 3 bias errors and 3 small angle errors. The 3 bias errors correspond, respectively to each axis of the gyroscope. The bias error signals are respectively applied to a portion of the gyroscope signal that is the measurement for the corresponding axis. The bias error signals are applied to the gyroscope (gyro) signal at summer 118 to correct gyro bias. The small angle errors are provided to the attitude update module to correct attitude angle.

The Kalman filter 160 is adapted based on a current acceleration mode of the attitude updating device 100 to provide accurate small angle and gyro bias errors consistent with the current acceleration mode. An adaptive measure R module 170 takes inputs from summer 128 (accelerometer) and summer 138 (magnetometer) and calculates a current acceleration mode that determines the adaption of the Kalman filter 160 (also referred to as an adaptive filter, or extended Kalman filter). The adaptive measure R module 170 determines the mode of the INS devices (e.g., Gyros & Accelerometers). In one embodiment, the mode is either non-acceleration mode (none or negligible acceleration), low acceleration mode (e.g., less than 1 g), or high acceleration mode (1 g or over). In other embodiments, along with corresponding adaptive extensions of the Kalman filter, additional acceleration modes may be utilized. Preferably, the acceleration modes are selected based on performance criteria of the gyroscopes. For example, a typical low-cost gyroscope will show patterns of error behavior different in each of discrete ranges of acceleration. The acceleration modes are chosen to include ranges of acceleration consistent with the performance of the gyroscope utilized as the 3-axis gyro 110.

Parameters that cause the Kalman filter 160 to implement a model of the gyroscope error for the current acceleration mode are loaded into the Kalman Filter 160. The gyroscope error model is, for example, a combination of a dynamic model and a measurement model as described above.

The Kalman Filter 160 operates on a residual value (Res) that is a difference between a measured \hat{f} and \hat{M} and a predicted \hat{f} and M. The measured \hat{f} and \hat{M} are the measured acceleration (e.g., accelerometer reading) and measured heading (e.g., magnetometer reading) respectively. The predicted \hat{f} and \hat{M} comprise the predicted acceleration (\hat{f}) and the predicted heading (\hat{M}) are predictions based on, for example, a model (H) of a current updated attitude X. The model H, for example, looks at current accelerations, current attitude and heading, etc, and determines the predicted values. For example, a rate of attitude change may applied to a current attitude to determine the predicted values. Equation 31 above describes one embodiment of a calculation for \hat{f}, and equation 35 describes one embodiment of a calculation for \hat{M}.

The attitude update is continuously performed in a process of instrument reading, compensation, adapting the Kalman filter, determining residual, operating on the residual with the adapted Kalman filter to determine δx, bias correcting the gyro readings with the bias portion of δx, and updating the attitude based on both the small angle portion of δx and the adjusted gyro readings. In one embodiment, the attitude is updated using a quaternion update as described above.

The current updated attitude X is output to one or more devices that utilize the current attitude X. The output is performed, for example, via a Universal Asynchronous Receiver Transmitter (UART).

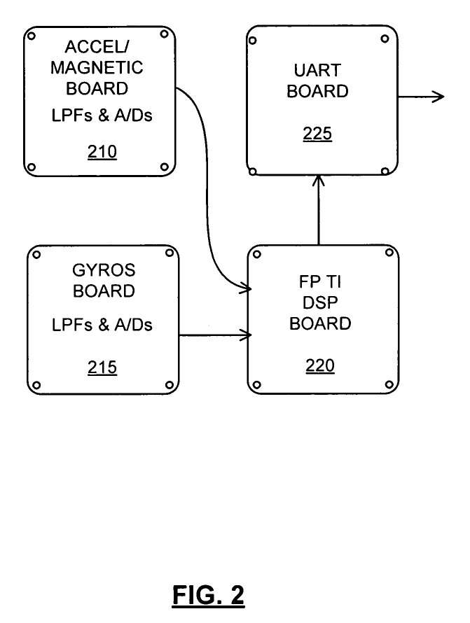

FIG. 2 is a diagram of a board arrangement according to an embodiment of the present invention. Other configurations of boards, or the re-arrangement of the functionality or individual components between the boards, or providing parts consistent with the present invention on more or less boards are possible based on the current disclosure. However, the present inventor finds that packaging components on the boards as illustrated, using industry standard parts and arranged to perform as shown in FIG. 1, provides for the opportunity to package the device in a small sized package consistent with current INS device packaging.

FIGS. 3A and 3B are an illustration of a packaging utilized in an embodiment of the present invention. Each of boards 210, 215, 220, and 225 are, for example, stacked horizontally in an electronic enclosure 300. The enclosure includes, for example, power (input) and attitude (output) ports (not shown). Standard power and communication connectors may be utilized as a hardware interface for the ports.

FIG. 4 is a high level flow chart of a process according to an embodiment of the present invention. At step 400, measurements are taken. The measurements are, for example, data from the INS instruments (e.g., gyroscopes, accelerometers, and magnetometers) of an AHRS. The measurement data is then filtered (e.g., LPF), and adjusted (e.g., temperature corrected) at step 405.

An attitude of the AHRS body frame is initialized at step 415. Steps 430 and 440 determine a current acceleration mode. At step 430, if the system is not accelerating, non-acceleration parameters in the Kalman filter are set-up. At step 445, a grade of acceleration of the system is determined. If the system is under low dynamic acceleration, step 450 sets up the Kalman filter with low dynamic parameters. If the system is under high dynamic acceleration, step 450 sets up the Kalman filter with high dynamic parameters. The Kalman filter, now adapted for the current acceleration mode, estimates attitude error and gyro bias (step 440). Based on the estimates, an attitude and gyro bias correction is then determined (step 460).

If it is time for attitude output using the attitude & gyro bias correction determined in step 460, a quaternion update of the initial attitude based on INS readings and the attitude & gyro bias correction is performed at step 422. The corrected attitude is then output at step 424.

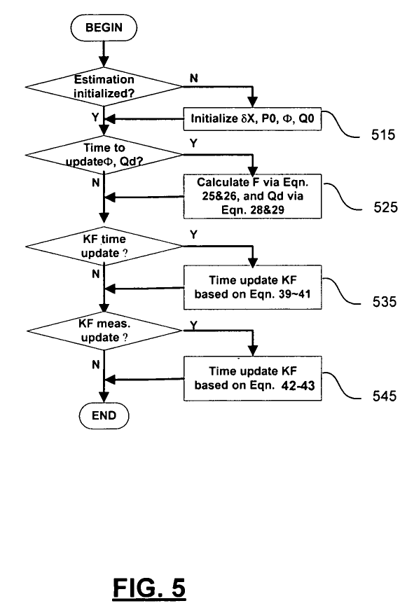

FIG. 5 is a flow chart of an initialization and update process of a Kalman filter according to an embodiment of the present invention. If the Kalman filter is not initialized, it is initialized with estimated or preset values (step 515). The preset values may be standard values applied to all units produced of the same type. In one embodiment, some values (e.g., P0 and Q0) are tested for each individual device and applied to the individual device's presets during production. However, presetting individual units is more costly in production, and estimated presets are adequate because the estimated presets are quickly updated through the continuous attitude update as described above.

At step 525, the attitude update module is updated, which comprises, for example, an update of the quaternion. The quaternion is updated, for example, as described in equations 25-29. The attitude update module then produces an updated attitude. The updated attitude is used to produce a predicted acceleration and heading (f and \hat{M}) and determine a residual (RES).

The Kalman filter is updated. The Kalman filter update is, for example, a two step process. At step 535, a time update of the Kalman filter is performed. The time update comprises, for example, an application of equations 39-41 discussed above. At step 545, a measurement update of the Kalman Filter is performed. The measurement update comprises, for example, an application of equations 42-43 discussed above.

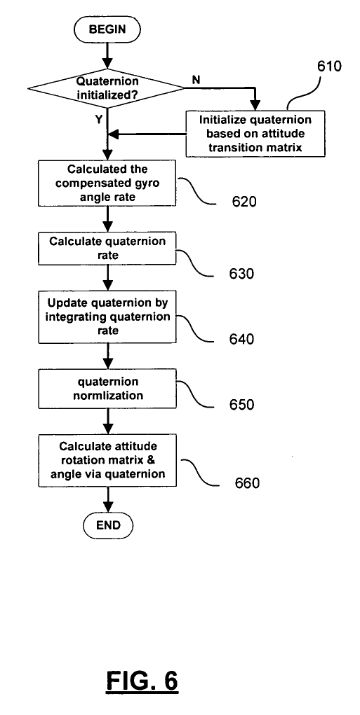

FIG. 6 is a flow chart of a quaternion update process according to an embodiment of the present invention. At step 610, if the quaternion has not been initialized, it is initialized based on an attitude transition matrix. For example, the quaternion is initialized via the application of equations 14-17 discussed above.

At step 620, a compensated gyro angle rate is calculated. Then, at step 630, the quaternion rate is calculated (e.g., an application of equation 10 discussed above).

At step 640, the quaternion is updated by integrating the quaternion rate. At step 650, the quaternion is normalized. The quaternion normalization is performed, for example, by an application of equation 11. And, at step 660, the attitude rotation and angle are calculated using the quaternion (e.g., an application of equation 12). Table 1 provides a listing of variable values consistent with the above disclosure.

TABLE 1

| VARIABLES | DEFINITION |
|---|---|
| R_{a2b} | Rotation matrix from the frame a to another frame b |
| R_{b2t} | Rotation matrix from the body to tangent frame |
| (φ, θ, ψ) | Euler attitude angles: roll, pitch, and yaw |
| g | Gravity of the earth |
| (\overline{f}ᵤ, \overline{f}ᵥ, \overline{f}_{w}) | The average measure of the earth gravity on three |
| | axes of the body frame |
| (p, q, r) | Gyro three axes' measurements in the body frame |
| | with respect to the inertial frame |
| q = [q₁ q₂ q₃ q₄]^{T} | Quaternion |
| δρ = ∴_{N}, ∴_{E}, ∴_{D}]^{T} | Small rotating angle error vector |
| X_{g} = [gₓ, g_{y}, g_{z}]^{T} | Gyro bias vector |
| [ω_{N} ω_{E} ω_{D]}^{T} | The angle rotating vector caused by earth rotation |
| | and system movements |
| F | The continuous time dynamic state transition matrix |
| Φ | The discrete time dynamic state transition matrix |
| Q | The continuous time process noise covariance |
| | matrix |
| Q_{d} | The discrete time process noise covariance matrix |
| σ_{g} | The standard deviation of the gyro measurement |
| | noise |
| σ_{qd} | The standard deviation of the gyro bias |
| [δρx] | The skew-symmetric matrix formed by the small |
| | rotation angle error vector δρ = ∈_{N}, ∈_{E}, ∈_{D}]^{T} |
| | to align the calculated tangent frame to |
| | the true tangent frame |
| H | The measurement transition matrix |
| R | The measurements covariance matrix |
| P | The state covariance matrix |
| [σₐ_{ₓ} σₐ_{_{y}} σₐ_{_{z}}] | The accelerometer noise standard deviation in the |
| | body frame |
| [σ_{ωN} σ_{ωE} σ_{ωD}] | The mapped accelerometer noise standard deviation |
| | on the tangent frame |
| α | The scalar dynamic acceleration residual |
| σ_{mc} | The standard deviation of the magnetic compass |
| | heading |
| Thld_{acc} | The threshold of the system acceleration dynamic |
| Thld_{big} | A big number close to infinity |

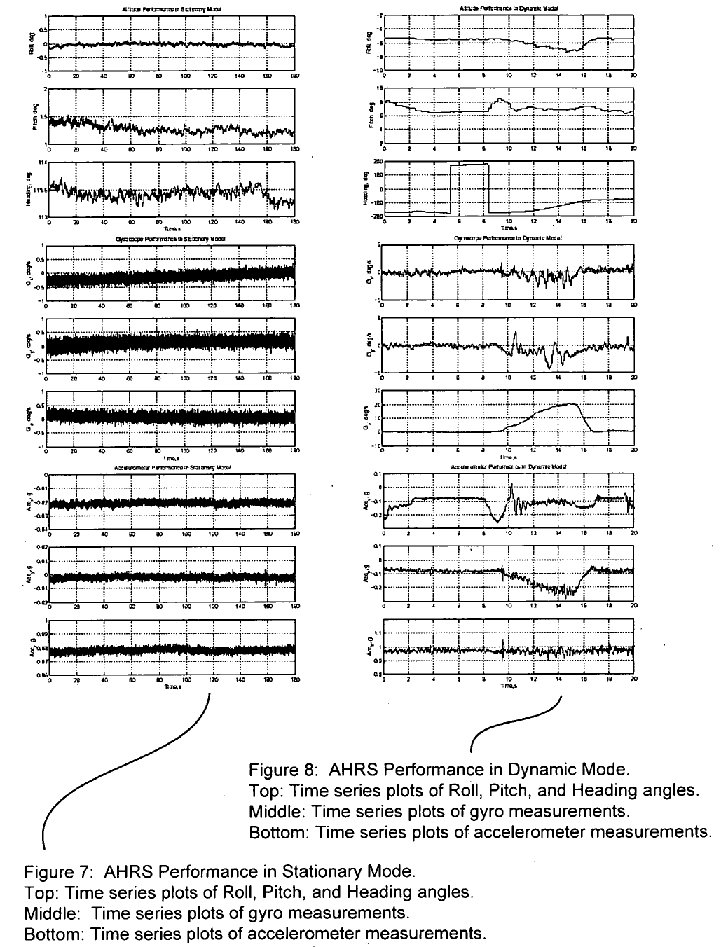

The present invention has been applied in a test device, and the results are now described. In stationary mode, the measurements of the system are collected when the system is stationary. The adaptive filter gain is based on the optimal stochastic estimation. The results are show in FIG. 7 and Tables 1-3. These results show that the standard deviations of the attitude and heading are within 0.1 degree, the angle rates are within 0.13 deg/s, and the accelerations are within 1.4 mg. The pitch has an angle of 1.27 deg which corresponds to an x-axis acceleration of −21 mg. When the system started, all gyroscopes had biases within 0.3 deg/s. It took about 100 seconds for the AHRS to estimate them correctly and to compensate the gyro measurements. This is clearly indicated in the middle plots of FIG. 7.

TABLE 1
Attitude Stochastic Characteristics in Stationary Mode

| | Roll | Pitch | Heading |
|---|---|---|---|
| Attitude | deg. | deg. | deg. |
| Mean | −0.035 | 1.27 | 113.41 |
| STD | 0.049 | 0.079 | 0.097 |

TABLE 2
Attitude Stochastic Characteristics in Stationary Mode

| | gyroₓ | gyro_{y} | Gyro_{z} |
|---|---|---|---|
| Attitude | deg/s | deg/s | deg/s |
| Mean | −0.128 | 0.120 | 0.056 |
| STD | 0.127 | 0.124 | 0.101 |

TABLE 3
Attitude Stochastic Characteristics in Stationary Mode

| Acceleration | Accₓ g | Acc_{y} g | Acc_{z} g |
|---|---|---|---|
| Mean | −0.021 | −0.002 | 0.978 |
| STD | 0.0013 | 0.0013 | 0.0014 |

In dynamic mode: In this mode, the AHRS is mounted on the car and involved various maneuvers. The car was first running with de-acceleration, stayed on a constant speed, made a right turn, then slowly stopped. In this testing, the adaptive filter was operating in deferent modes and the measurements are plotted in FIG. 8. It can be seen that there was a negative roll angle and a positive pitch angle corresponding to a negative acceleration in both x-axis and y-axis accelerometers at constant speed.

Thus, the present invention provides a miniature MEMS based attitude and heading reference system with an adaptive filter achieving a 120 Hz update rate. Analysis of data from the experiments shows that a miniature MEMS based AHRS is capable of achieving 0.1 degree accuracy in stationary mode and gives reasonable results in the various dynamic modes.

The present invention may take many forms including a device or method. In one embodiment, the present invention is an attitude determination device, comprising, a mode mechanism configured to determine a current acceleration mode of the device; and a filter adaptable to the current acceleration mode and configured to determine an estimated error of an inertial device based on the current acceleration mode. In one embodiment, the filter is a Kalman filter that operates on a difference between a measured inertial value and a predicted inertial value to determine the estimated error of the inertial device. The error of the inertial device comprises, for example, at least one of a small angle error and a bias error. In one embodiment, the operation of the Kalman filter is adapted to the current acceleration mode by applying a set of parameters to the Kalman filter that match the current acceleration mode. In one embodiemnt, the Kalman filter comprises a six state adaptive filter wherein the six states comprise three tilt angles of attitude and bias errors from gyroscopes of the three tilt angles.

The present invention is an improvement in an attitude determination device having at least one inertial device, the improvement comprising, an adaptive error device set up to determine an accurate error estimate of at least one of the inertial devices based on operation of a Kalman filter configured to reflect a current acceleration mode of the attitude determination device. The improvement may further comprises, for example, the Kalman filter being further configured to be adaptable to a plurality of acceleration mode and to adapt to the current acceleration mode in real-time.

The present invention includes methods implementing the invention. For example, a method, comprising the steps of, determining a set of operational ranges of a device wherein each operational range of the device is defined by an external factor that affects performance of the device and at least one characteristic of the affected performance can be modeled, setting up a model of the affected performance, providing a set of parameters for the model for each operational range, programming a processing device to determine a current operational range, apply the set of parameters for the current operational range to the model, and run the model to estimate affected performance of the device in the current operational range. Addition steps may include, for example, a step of packaging the device, processing device, model, and parameter into an electronic enclosure. The model is, for example, a Kalman filter. The various components operated on by the method include, for example, that the device is a gyroscope or other inertial device, the processing device is a floating point processor, the model comprises a Kalman filter, and the parameters comprise a set of values for the model to estimate error performance of the device in the operational range. The device itself, for example, the device comprises a MEMs based 3-axis Inertial Measurement Unit (IMU). And, the operational ranges comprise, for example, ranges of acceleration affecting the device.

Another example method implementing the present invention includes the steps of, initializing an attitude, reading a low performance inertial device, estimating an error of the low performance inertial device, and updating the attitude based on the read of the inertial device and the estimated error. In one embodiment, the step of estimating error comprises performing a Kalman filter operation that incorporates both the dynamic model and the measurement model. In the case of a Kalman filter embodiment, the Kalman filter is adapted, for example, based on a scenario in which the inertial measurement is made. The scenario is, for example, an amount of acceleration imposed on the low performance inertial device while reading the low performance inertial device. In one embodiment, the Kalman filter is adaptable to at least 3 scenarios, comprising a non-acceleration scenario, a low-acceleration scenario, and a high-acceleration scenario. In yet another embodiment, each adaption of the Kalman filter comprises a set of parameters fitted to the adaption so as to direct operation of the Kalman filter to produce an accurate error estimate of the low performance inertial device in the adaption scenario.

The present invention may be implemented in a device comprising, an inertial device configured to make inertial readings, a dynamic model of the inertial device, a measurement model of the inertial measurement device, and a Kalman filter fitted to both the dynamic model and the measurement model and configured to produce an estimated error of the inertial device. The dynamic model comprises a process that calculates an approximation of Q_{d}_{ₖ}, approximated via, for example, a series comprising

$${Q}_{{d}_{k}} = {\sum }_{1}^{N} {Φ}_{( {t}_{i + 1} , {t}_{i} )} {Q}_{( {t}_{i} )} {Φ}_{( {t}_{i + 1} , {t}_{i} )}^{T} d {T}_{i} .$$

As noted further above, Q(ti) may comprise

$$Q ( t ) = [ \begin{matrix}{Q}_{g} & 0 \\ 0 & {Q}_{gd}\end{matrix} ] ,$$

and Φ_{*t}_{ᵢ₊₁}_{,t}_{ᵢ}₎ may comprise Φ₍ₜ_{ₙ}_{,kT)}=Φ₍ₜ_{ₙ}_{,t}_{_{n−1}}₎Φ₍ₜ_{_{n−1}}_{,kT)}.

In one embodiment a measurement model of the present invention comprises an accelerometer measurement model in a non-acceleration mode and a magnetic compass measurement model. The accelerometer measurement model, δf, for example, comprises:

$$δ f = [ \begin{matrix}0 & - g & 0 \\ g & 0 & 0 \\ 0 & 0 & 0\end{matrix} ] [ \begin{matrix}{∈}_{N} \\ {∈}_{E} \\ {∈}_{D}\end{matrix} ] + {n}^{t} , where$$

\hat{R}_{b2t}=(I−[δρ×])R_{b2t}+h.o.t.'s with

$$[ δρ \times ] = [ \begin{matrix}0 & {∈}_{D} & - {∈}_{E} \\ - {∈}_{D} & 0 & {∈}_{N} \\ {∈}_{E} & - {∈}_{N} & 0\end{matrix} ]$$

being a skew-symmetric matrix formed by a small rotation angle error vector comprising δρ=[ε_{N},ε_{E},ε_{D}]^{T} which provides an alignment difference between a calculated tangent frame and a true tangent frame, and h.o.t.'s being an error of a high order term. In addition, the magnetic compass measurement model, for example, models a residual between a magnetic compass reading and a calculated heading, and the residual may comprise

In one embodiment, the dynamic model comprises a 3 axis small angle rotation vector and a 3-axis bias error defined as

$$δ x = [ \begin{matrix}δρ \\ {x}_{g}\end{matrix} ] ,$$

wherein δρ is the 3-axis small angle rotation error vector defined as δρ=[ε_{N},ε_{E},ε_{D}]^{T} and x_{g} is the 3-axis bias error being the small rotation angle error vector, and x_{g}=[gₓ,g_{y},g_{z}]^{T}

In one embodiment, the Kalman filter is adapted to each of a set of acceleration modes that affect performance of the inertial measurement device.

In one embodiment, the invention includes a set of parameters for each of a series acceleration modes, and an adaptation mechanism configured to apply the set of parameters matching an acceleration mode of the inertial measurement device.

In one embodiment, the dynamic model is further defined as

$$[ \begin{matrix}δ \dot{ρ} \\ {\dot{x}}_{g}\end{matrix} ] = [ \begin{matrix}{F}_{ρρ} & {F}_{ρ {x}_{g}} \\ 0 & {F}_{{x}_{g} {x}_{g}}\end{matrix} ] [ \begin{matrix}δρ \\ {x}_{g}\end{matrix} ] + [ \begin{matrix}{ω}_{ρ} + {υ}_{g} \\ {ω}_{g}\end{matrix} ] ;$$

ωρ+ν_{g} comprise spectral densities of a measurement noise process of the inertial device;

$${F}_{ρρ} = [ \begin{matrix}0 & {ω}_{D} & - {ω}_{E} \\ - {ω}_{D} & 0 & {ω}_{N} \\ {ω}_{E} & - {ω}_{N} & 0\end{matrix} ] , where {ω}_{N} = {ω}_{ie} cos λ + \frac{{υ}_{E}}{{R}_{Φ} + h} , \\ {ω}_{E} = \frac{{υ}_{N}}{{R}_{λ} + h} , and {ω}_{D} = {ω}_{ie} sin λ - \frac{tan ( λ ) {υ}_{E}}{{R}_{Φ} + h} ;$$

$${F}_{ρ {X}_{g}} = \frac{\partial ρ}{\partial {ω}_{ib}^{b}} \frac{\partial {ω}_{ib}^{b}}{\partial {x}_{g}} = {R}_{b 2 t} \frac{\partial {ω}_{ib}^{b}}{\partial {x}_{g}} = {R}_{b 2 t} ; and$$

Fₓ_{_{g}}ₓ_{_{g}}=0, where x_{g} is modeled as a random walk process with Fₓ_{_{g}}ₓ_{ₓ} being 0.

The present invention may be implemented in a device comprising, an inertial device configured to make inertial readings, a dynamic model of the inertial device, a measurement model of the inertial measurement device, and a Kalman filter fitted to both the dynamic model and the measurement model and configured to produce an estimated error of the inertial device. The dynamic model comprises a process that calculates an approximation of Q_{d}_{ₖ}, approximated via, for example, a series comprising

$${Q}_{{d}_{k}} = {\sum }_{1}^{N} {Φ}_{( {t}_{i + 1} , {t}_{i} )} {Q}_{( {t}_{i} )} {Φ}_{( {t}_{i + 1} , {t}_{i} )}^{T} d {T}_{i} .$$

and, Q(ti) comprises

$$Q ( t ) = [ \begin{matrix}{Q}_{g} & 0 \\ 0 & {Q}_{gd}\end{matrix} ] ,$$

and Φ₍ₜ_{ᵢ₊₁}_{,t}_{ᵢ}₎ comprises Φ₍ₜ_{ₙ}_{,kT)}=Φ₍ₜ_{_{n−1}}₎Φ₍ₜ_{_{n−1}}_{,kT)}.

The present invention may be implemented in a device comprising, an inertial device configured to make inertial readings, a dynamic model of the inertial device, a measurement model of the inertial measurement device, and a Kalman filter fitted to both the dynamic model and the measurement model and configured to produce an estimated error of the inertial device, and the measurement model comprises an accelerometer measurement model in a non-acceleration mode and a magnetic compass measurement model. In one embodiment, the accelerometer measurement model δf comprises:

$$δ f = [ \begin{matrix}0 & - g & 0 \\ g & 0 & 0 \\ 0 & 0 & 0\end{matrix} ] [ \begin{matrix}{∈}_{N} \\ {∈}_{E} \\ {∈}_{D}\end{matrix} ] + {n}^{t} , where$$

\hat{R}_{b2t}=(I−[δρ×])R_{b2t}+h.o.t.'s, with

$$[ δρ \times ] = [ \begin{matrix}0 & {∈}_{D} & - {∈}_{E} \\ - {∈}_{D} & 0 & {∈}_{N} \\ {∈}_{E} & - {∈}_{N} & 0\end{matrix} ]$$

being a skew-symmetric matrix formed by a small rotation angle error vector comprising δρ=[ε_{N},ε_{E},ε_{D}]^{T} which provides an alignment difference between a calculated tangent frame and a true tangent frame, and h.o.t.'s being an error of a high order term.

The present invention may be implemented in a device comprising, an inertial device configured to make inertial readings, a dynamic model of the inertial device, a measurement model of the inertial measurement device, and a Kalman filter fitted to both the dynamic model and the measurement model and configured to produce an estimated error of the inertial device, and the dynamic model comprises a 3 axis small angle rotation vector and a 3-axis bias error defined as

$$δ x = [ \begin{matrix}δρ \\ {x}_{g}\end{matrix} ] ,$$

wherein δρ is the 3-axis small angle rotation error vector defined as δρ=[ε_{N},ε_{E},ε_{D}]^{T} and x_{g} is the 3-axis bias error being the small rotation angle error vector, and x_{g}=[gₓ,g_{y},g_{z}]^{T}

The present invention may be implemented in a device comprising, an inertial device configured to make inertial readings, a dynamic model of the inertial device, a measurement model of the inertial measurement device, and a Kalman filter fitted to both the dynamic model and the measurement model and configured to produce an estimated error of the inertial device, and the Kalman filter is adapted to each of a set of acceleration modes that affect performance of the inertial measurement device.

The present invention may be implemented in a device comprising, an inertial device configured to make inertial readings, a dynamic model of the inertial device, a measurement model of the inertial measurement device, and a Kalman filter fitted to both the dynamic model and the measurement model and configured to produce an estimated error of the inertial device, and a set of parameters for each of a series acceleration modes, and an adaptation mechanism configured to apply the set of parameters matching an acceleration mode of the inertial measurement device. In one embodiment, the dynamic model is further defined as

$$[ \begin{matrix}δ \dot{ρ} \\ {\dot{x}}_{g}\end{matrix} ] = [ \begin{matrix}{F}_{ρρ} & {F}_{ρ {x}_{g}} \\ 0 & {F}_{{x}_{g} {x}_{g}}\end{matrix} ] [ \begin{matrix}δρ \\ {x}_{g}\end{matrix} ] + [ \begin{matrix}{ω}_{ρ} + {υ}_{g} \\ {ω}_{g}\end{matrix} ] ;$$

ω_{ρ}+ν_{g} comprise spectral densities of a measurement noise process of the inertial device;

$${F}_{ρρ} = [ \begin{matrix}0 & {ω}_{D} & - {ω}_{E} \\ - {ω}_{D} & 0 & {ω}_{N} \\ {ω}_{E} & - {ω}_{N} & 0\end{matrix} ] , where {ω}_{N} = {ω}_{ie} cos λ + \frac{{υ}_{E}}{{R}_{Φ} + h} , \\ {ω}_{E} = \frac{{υ}_{N}}{{R}_{λ} + h} , and {ω}_{D} = {ω}_{ie} sin λ - \frac{tan ( λ ) {υ}_{E}}{{R}_{Φ} + h} ;$$

$${F}_{ρ {X}_{g}} = \frac{\partial ρ}{\partial {ω}_{ib}^{b}} \frac{\partial {ω}_{ib}^{b}}{\partial {x}_{g}} = {R}_{b 2 t} \frac{\partial {ω}_{ib}^{b}}{\partial {x}_{g}} = {R}_{b 2 t} ; and$$

Fₓ_{_{g}}ₓ_{_{g}}=0, where x_{g} is modeled as a random walk process with Fₓ_{_{g}}ₓ_{_{g}} being 0.

In describing preferred embodiments of the present invention illustrated in the drawings, specific terminology is employed for the sake of clarity. However, the present invention is not intended to be limited to the specific terminology so selected, and it is to be understood that each specific element includes all technical equivalents which operate in a similar manner. For example, when a 3-axis gyroscope, accelerometer, or magnetometer, any other equivalent device, or other device having an equivalent function or capability, whether or not listed herein, may be substituted therewith. Furthermore, the inventors recognize that newly developed technologies not now known may also be substituted for the described parts and still not depart from the scope of the present invention. All other described items, including, but not limited to the described processes, Kalman filter, summers, processing device, i/o modules, etc should also be consider in light of any and all available equivalents.

Portions of the present invention may be conveniently implemented using a digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art based on the present disclosure.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical discs, DVD, CD-ROMS, micro-drive, and magneto-optical disks, ROMs, RAMS, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including, but not limited to, programming the above described equations, filter operations, and the display, storage, or communication of results according to the processes of the present invention.

The present invention may suitably comprise, consist of, or consist essentially of, any of element (the various parts or features of the invention, e.g., adaptive Kalman filter, attitude update module, summers, processors) and their equivalents whether or not specifically described herein. Further, the present invention illustratively disclosed herein may be practiced in the absence of any element, whether or not specifically disclosed herein. Instead of the MEMS based inertial sensors, the technology can extended to other low-level inertial sensors to improve and enhance the performance of the system.

Obviously, numerous modifications and variations of the present invention are possible in light of the above teachings. It is therefore to be understood that within the scope of the appended claims, the invention may be practiced otherwise than as specifically described herein.

1. A method, comprising the steps of:
determining an acceleration mode;
adapting a filter with parameters matching the determined acceleration mode; and
applying the adapted filter to a correction value to determine an estimated error.

2. The method according to claim 1, wherein:
the correction value is at least one of a small angle error and bias error of an inertial navigation device.

3. The method according to claim 2, wherein the correction value is a residual of a predicted and measured value comprising at least one of a small angle error and bias error of an inertial navigation device.

4. The method according to claim 3, wherein the inertial navigation device is an Inertial Measurement Unit (IMU).

5. The method according to claim 3, wherein the filter comprises a Kalman filter.

6. The method according to claim 5, wherein the parameters comprise parameters selected to enable the Kalman filter to produce accurate estimate error determinations for the IMU under the determined acceleration.

7. The method according to claim 5, wherein the Kalman filter is configured to perform a time update and a measurement update for the determined acceleration.

8. A method, comprising the steps of:
determining an acceleration mode;
adapting a Kalman filter with parameters consistent with the determined acceleration mode; and
applying the adapted Kalman filter to a correction value to determine an estimated error of an inertial navigation device;
wherein:
the correction value comprises a difference between a measured inertia value of the inertial navigation device and a predicted inertia value;
the determined acceleration mode comprises one of a non-acceleration mode, a low acceleration mode, and a high acceleration mode; and
the parameters comprise non-acceleration Kalman filter parameters when the determined acceleration mode is the non-acceleration mode, the parameters comprise low acceleration Kalman filter parameters when the determined acceleration mode is the low acceleration mode, and the parameters comprise high acceleration Kalman filter when the determined acceleration mode is the non-acceleration mode.

9. The method according to claim 8, wherein:
the error correction value is at least one of a small angle error and bias error of an inertial navigation device.

10. The method according to claim 9, wherein the inertial navigation device is an Inertial Measurement Unit (IMU).

11. An attitude determination device, comprising:
an inertial measurement device;
an error estimator configured to produce an estimated error of the inertial measurement device; and
an attitude update device configured to update an attitude based on measurements from the inertial measurement device and the estimated error;
wherein the estimated error is based on a relationship that relates a dynamic model of error of the inertial measurement device and a measurement model of the inertial measurement device to the estimated error.

12. The method according to claim 11, wherein the dynamic model comprises a small rotation angle error vector of the inertial measurement device and a bias vector of the inertial measurement device combined to estimate the error of the inertial measurement device.

13. The attitude determination device according to claim 11, wherein the dynamic model comprises an error state model comprising a Kalman filter adapted for multiple operating conditions.

14. The attitude determination device according to claim 13, wherein the Kalman filter is adapted for non-acceleration, low acceleration, and high acceleration operating conditions.

15. The attitude determination device according to claim 12, wherein the Kalman filter is configured to implement the dynamic model and the measurement model.

16. The attitude determination device according to claim 15, wherein the measurement model comprises an accelerometer measurement and a magnetic compass measurement.

17. The attitude determination device according to claim 15, wherein the dynamic model is based on
$$δ x = [ \begin{matrix}δρ \\ {x}_{g}\end{matrix} ]$$
with δρ=[ε_{N},ε_{E},ε_{D}]^{T} being a small rotation angle error vector of the gyroscope, and x_{g}=[gₓ,g_{y},g_{z}]^{T} being a bias vector of the gyroscope.

18. The attitude determination device according to claim 11, wherein the error estimator includes a state model comprising
$$δ x = [ \begin{matrix}δρ \\ {x}_{g}\end{matrix} ]$$
with δρ=[ε_{N},ε_{E},ε_{D}]^{T} being a small rotation angle error vector of the gyroscope, and x_{g}=[gₓ,g_{y},g_{z}]^{T} being a bias vector of the gyroscope.

19. The attitude determination device according to claim 18, wherein the error state model is a dynamic error state model comprising:
$$[ \begin{matrix}δ \dot{ρ} \\ {\dot{x}}_{g}\end{matrix} ] = [ \begin{matrix}{F}_{ρρ} & {F}_{ρ {x}_{g}} \\ 0 & {F}_{{x}_{g} {x}_{g}}\end{matrix} ] [ \begin{matrix}δρ \\ {x}_{g}\end{matrix} ] + [ \begin{matrix}{ω}_{ρ} + {υ}_{g} \\ {ω}_{g}\end{matrix} ] , where$$
$${F}_{ρρ} = [ \begin{matrix}0 & {ω}_{D} & - {ω}_{E} \\ - {ω}_{D} & 0 & {ω}_{N} \\ {ω}_{E} & - {ω}_{N} & 0\end{matrix} ] ;$$
$${F}_{ρ {X}_{g}} = \frac{\partial ρ}{\partial {ω}_{ib}^{b}} \frac{\partial {ω}_{ib}^{b}}{\partial {x}_{g}} = {R}_{b 2 t} \frac{\partial {ω}_{ib}^{b}}{\partial {x}_{g}} = {R}_{b 2 t} ; {F}_{{x}_{g} {x}_{g}} = 0 ;$$
$${ω}_{N} = {ω}_{ie} cos λ + \frac{{υ}_{E}}{{R}_{Φ} + h} ; {ω}_{E} = \frac{{υ}_{N}}{{R}_{λ} + h} ; and$$
$${ω}_{D} = {ω}_{ie} sin λ - \frac{tan ( λ ) {υ}_{E}}{{R}_{Φ} + h} .$$

20. The attitude determination device according to claim 19, wherein x_{g} is modeled as a random walk process with Fₓ_{_{g}}ₓ_{_{g}} being 0.

21. A method, comprising the steps of:
measuring at least one inertia based force acting on a body;
identifying a set of parameters that define operation of a characteristic model under the measured inertia;
applying the set of parameters to the model; and
determining the characteristic under the measured inertia from the model.

22. The method according to claim 21, wherein the model is a Kalman filter that is adaptable to plural sets of parameters, each set of parameters defining operation of the Kalman filter for a predetermined range of inertial forces.

23. The method according to claim 21, wherein the model is an error model of an inertial measurement device.

24. The method according to claim 23, wherein the inertial measurement device is a gyroscope.

25. The method according to claim 23, wherein the inertial measurement device is a 3-axis gyroscope.

26. The method according to claim 23, wherein the inertial measurement device is a MEMS based Inertial Measurement Unit (IMU).

27. The method according to claim 21, wherein:
the model is a Kalman filter that is adaptable to plural sets of parameters, each set of parameters defining operation of the Kalman filter for a predetermined range of inertial forces;
the characteristic model is an estimated error model for each axis of a 3 axis gyroscope; and
said step of measuring comprises measuring the inertial force in each axis of the 3-axis gyroscope.

28. The method according to claim 27, further comprising the step of applying the estimated error from the model to an attitude determination device to compensate for error.

29. The method according to claim 27, further comprising the step of applying the estimated error from the model to a quaternion based attitude update process.

30. The method according to claim 27, further comprising the steps of:
determining an initial attitude of the body; and
updating the attitude of the body taking into account the estimated error from the model.

31. The method according to claim 30, wherein the step of updating the attitude comprises updating the attitude as a strapdown INS.

32. The method according to claim 31, wherein the strapdown INS attitude update comprises a quaternion based attitude update.

33. The method according to claim 32, wherein the quaternion based attitude update comprises a quaternion propagation comprising the steps of,
integrating a differential equation relating the quaternion (q) and an angle rate for quaternion propagation to determine the quaternion;
normalizing the quaternion; and
rotating a frame of the body to a tangent frame representative of the quaternion propagation.

34. The method according to claim 33, wherein the differential equation comprises:
$$\dot{q} = \frac{1}{2} [ \begin{matrix}0 & r & - q & p \\ - r & 0 & p & q \\ q & - p & 0 & r \\ - p & - q & - r & 0\end{matrix} ] q = [ \begin{matrix}{q}_{4} & - {q}_{3} & {q}_{2} \\ {q}_{3} & {q}_{4} & - {q}_{1} \\ - {q}_{2} & {q}_{1} & {q}_{4} \\ - {q}_{1} & - {q}_{2} & - {q}_{3}\end{matrix} ] [ \begin{matrix}p \\ q \\ r\end{matrix} ]$$
where gyro measurements are denoted as ω_{ib}^{b}=[p,q,r]^{T} with p, q, and r being three-axis angle rate in the body frame.

35. The method according to claim 33, wherein normalization of the quaternion comprises:
$${q}_{n} = \frac{q}{{q}^{T} q}$$
where

36. The method according to claim 33, wherein the step of rotating comprises the step of calculating a rotation matrix from the body frame to the tangent frame R_{b2t} such that:
R_{b2t}=(q₄²−p^{T}p)I_{3×3}+2pp^{T}−2q₄[p×] (12)
with p=[q₁,q₂,q₃]^{T}, I_{3×3} being the identity matrix, and
$$[ px ] = [ \begin{matrix}0 & - {q}_{3} & {q}_{2} \\ {q}_{3} & 0 & - {q}_{1} \\ - {q}_{2} & {q}_{1} & 0\end{matrix} ] .$$

37. The method according to claim 38, further comprising the step of recalculating q as:
$${q}_{4} = \pm \frac{1}{2} {( 1 + {R}_{11} + {R}_{22} + {R}_{33} )}^{0.5}$$
$${q}_{1} = \frac{1}{4 {q}_{4}} ( {R}_{23} - {R}_{32} ) ;$$
$${q}_{2} = \frac{1}{4 {q}_{4}} ( {R}_{31} - {R}_{13} ) ; and$$
$${q}_{3} = \frac{1}{4 {q}_{4}} ( {R}_{12} - {R}_{21} ) .$$

38. A six state dynamic model, comprising:
an input mechanism configured to retrieve small angle and bias information;
a dynamic model comprising a 3 axis small angle rotation vector and a 3-axis bias error defined as
$$δ x = [ \begin{matrix}δρ \\ {x}_{g}\end{matrix} ] ,$$
wherein δρ is the 3-axis small angle rotation error vector defined as δρ=[ε_{N},ε_{E},ε_{D}]^{T} and x_{g} is the 3-axis bias error being the small rotation angle error vector, and x_{g}=[gₓ,g_{y},g_{z}]^{T}; and
a processing device configured to calculate the model to produce δx.

39. The six state dynamic model according to claim 38, further comprising a Kalman filter, wherein the six state dynamic model is fitted to the Kalman filter, and the Kalman filter is configured to be adapted to each of a series of acceleration modes.

40. The six state dynamic model according to claim 39, further comprising a measurement model fitted to the Kalman filter.

41. The six state model according to claim 40, wherein:
the Kalman filter is configured to be adapted to each of,
a non acceleration mode, such that, when data processed by the Kalman filter from a non-accelerating inertial measurement device, the Kalman filter produces a non-acceleration error estimate of the inertial measurement device,
a low acceleration mode, such that, when data processed by the Kalman filter from a low-accelerating inertial measurement device, the Kalman filter produces a low-acceleration error estimate of the inertial measurement device, and
a high acceleration mode, such that, when data processed by the Kalman filter from a high-accelerating inertial measurement device, the Kalman filter produces a high-acceleration error estimate of the inertial measurement device,

42. An adaptive filter, comprising a set of states for estimating errors;
a time transition matrix for updating the states; and
an adaptive update mechanism configured to adapt operation of the time transition matrix based on an operational mode of the adaptive filter.

43. The adaptive filter according to claim 42, wherein the adaptive filter is a six state filter comprising 3 tilt angle states and 3 bias error states each corresponding to an axis of a 3-axis gyro.

44. The adaptive filter according to claim 42, wherein the time transition matrix comprises a Kalman filter adaptable to each of the operational modes.

45. The adaptive filter according to claim 42, wherein the operational modes comprise a non accelerator mode, a low dynamic mode, and a high dynamic mode.

46. The adaptive filter according to claim 43, wherein the gyroscope comprises a MEMS based Inertial Measurement Unit (IMU).

47. The adaptive filter according to claim 42, wherein further comprising an accelerometer and a compass configured to update the time transition matrix.

48. An adaptive filter configured to determine gyro and bias errors for use in an inertial device comprising 3 gyroscopes wherein the adaptive filter has at least six states comprising three tilt angles detected by the gyroscopes and a bias error for each gyroscope and the adaptive filter includes at least three adaptive states including a no acceleration mode, a low acceleration mode, and a high acceleration mode.

49. The adaptive filter according to claim 48, wherein a current adaptive state of the adaptive filter is determined by an analysis of accelerometer data.

50. The adaptive filter according to claim 48, wherein the adaptive filter is implemented on a processing board of the inertial device within an industry standard INS device enclosure.

51. The adaptive filter according to claim 50, wherein the gyroscopes are integrated into a single 3 axis MEMS based device.
